(19) United States
(12) Patent Application Publication
(10) Pub. No.: US 2007/0197416 A1
(43) Pub. Date: Aug. 23, 2007

(54) Bleach activators and method for the production thereof

(75) Inventors: Ulrich Pegelow, Dusseldorf (DE); Thomas Holderbaum, Hilden (DE); Arnd Kessler, Monheim-Baumberg (DE); Maren Jekel, Willich (DE); Christian Nitsch, Dusseldorf (DE)

Correspondence Address: CONNOLLY BOVE LODGE & HUTZ, LLP, P O BOX 2207, WILMINGTON, DE, 19899, US

(73) Assignee: Henkel KGaA, Dusseldorf (DE)

(21) Appl. No.: 10/592,272

(22) PCT Filed: Jan. 12, 2005
(86) PCT No.: PCT/EP05/00286

§ 371 Date: Sep. 8, 2006

(30) Foreign Application Priority Data
Mar. 12, 2004 (DE) 10 2004 012 568.6

(51) Int. Cl. C11D 3/395

(52) U.S. Cl. 510/302; 510/314

(57) ABSTRACT

Bleach activator compatibility with bleach-sensitive dyestuffs can be improved in accordance with various embodiments of the invention including methods for producing coated bleach activators which methods comprise: granulating at least one bleach activator with at least one binding agent to form a granulated material; coating the granulated material with a solution or dispersion of at least one complexing agent to form a coated granulated material; and drying the coated granulated material.

The present invention relates to coated bleach activators, a method for the production thereof, and their use preferably in colored washing or cleaning agents, in particular cleaning agent tablets, that are utilized for cleaning dishes in automatic dishwashers.

Agents that contain bleach activators are extensively described in the existing art. The agents usually contain bleaching agents whose action is to be reinforced by the activators. One important utilization sector for agents containing bleaching agents and bleach activators is washing or cleaning agents. These agents usually contain one or more detergency builders, bleaching agents, bleach activators, corrosion protection agents, and surfactants. In order to make available to the consumer a typical and unmistakable product, these agents are usually both scented and colored. A number of requirements are applied to the dyes: they must color the cleaning agent that is to be colored in permanent and visually perceptible fashion even when used in low concentrations, and must not discolor or fade even during extended storage or at elevated temperature. For this, it is necessary for the dyes that are used to be chemically inert with respect to the ingredients that are in some cases aggressive (e.g. bleaching agents, alkali carriers), and must not break down other ingredients or themselves decompose. Because cleaning agent tablets that are on the market are often embodied with two colors for aesthetic reasons, at the phase boundary between differently colored regions there must also be no fading of the colored phase or any transfer of color into brighter or uncolored regions.

In the compact “tablet” presentation form, however, the contact between the dye and other dye-destabilizing constituents (in particular bleaching agents and/or bleach activators) is so intimate that during extended storage, color changes can occur that negatively affect the appearance of the shaped elements. Here as well, it has been found that the obvious separation of bleaching agent and dye into different regions of the tablet does not of itself represent a solution: even with this technical feature, the problems of fading and color transfer occur at the phase boundary, and result in visually unacceptable tablets.

In order to enhance the stability of bleaching agents and bleach activators, but also in order to make these substances less aggressive to their environment, it is established existing art in this technology to equip them with coatings that separate the environment and the bleaching agent or bleach activator from one another.

EP 482 807 B1, for example, discloses the combined granulation of TAED with binding agents, and subsequent coating of the granular material particles with inorganic salts.

It has been found, however, that the solutions disclosed in the existing art are not entirely satisfactory. In particular, the stability of dyes in the presence of the coated bleach activators of the existing art is often insufficient.

The object thus existed of discovering coated bleach activators, and a production method for such bleach activators, that can be used even in the presence of non-bleach-stable dyes, with no need to accept the disadvantages referred to above.

It has now been found that a special coating on specially prepared bleach activators results in greatly improved compatibility of the bleach activators with bleach-sensitive dyes.

The subject matter of the present invention, in a first embodiment, is a method for producing coated bleach activators characterized by the steps of
i) granulating at least one bleach activator with a binding agent;
ii) coating the granular materials from step a) with a solution or dispersion of at least one complexing agent;
iii) drying the coated granular materials.

In the first step of the method according to the present invention, at least one bleach activator is granulated with at least one binding agent. This step can easily be performed in a wide variety of granulation systems. In a suitable mixing and granulating apparatus, for example in corresponding systems of the Eirich mixer or Lodige mixer type, for example a plowshare mixer of the Lodige company, or a mixer of the Schugi company, a bed of solid material is provided and is then granulated with the addition of a granulating liquid, at circumferential speeds of the mixing elements preferably between 2 and 7 m/s (plowshare mixer) or 3 to 50 m/s (Eirich, Schugi), in particular between 5 and 20 m/s. Simultaneously, in a manner known per se, a predetermined particle size of the granular material can be set. The granulation and mixing process requires only a very short time period of, for example, approximately 0.5 to 10 minutes, in particular approximately 0.5 to 5 minutes (Eirich mixer, Lödige mixer) to homogenize the mixture and form the pourable granular material. In the Schugi mixer, on the other hand, a residence time of 0.5 to 10 seconds is normally sufficient to yield a pourable granular material. Mixers suitable for performing this method step are, for example, Eirich® series R or RV mixers (trademark of Maschinenfabrik Gustav Eirich, Hardheim), the Schugi® Flexomix, the Fukae® FS-G mixer (trademark of Fukae Powtech, Kogyo Co., Japan), the Lödige® FM, KM, and CB mixers (trademarks of Lödige Maschinenbau GmbH, Paderborn), or the Drais® series T or K-T (trademarks of Drais-Werke GmbH, Mannheim).

It is also possible according to the present invention to arrange several of the aforementioned mixers in series. The following combinations of successive mixers are particularly suitable here:
Lödige CB/Lödige KM
Lödige KM/Schugi Flexomix
Schugi Flexomix/Lödige KM/Schugi Flexomix
Schugi Flexomix/Lödige CB
Lödige CB/Löbdige KM/Schugi Flexomix

Granulation can be accomplished by providing bleach activator and binding agent as a bed of solid material, and granulating while adding a granulating liquid, preferably an aqueous solution. Preferably, however, the bleach activator is provided as a solid, and is granulated while adding a solution of the binding agent.

Usable as a bleach activator according to the present invention are, for example, compounds that contain one or more N- or O-acyl groups, such as substances from the class of the anhydrides, the esters, the imides and the acylated imidazoles or oximes. Examples are tetraacetylethylenediamine TAED, tetraacetylmethylenediamine TAMD, and tetraacetylhexylenediamine TAHD, but also pentaacetylglucose PAG, 1,5-diacetyl-2,2-dioxohexahydro -1,3,5-triazine DADHT, and isatosic acid anhydride ISA.

It is additionally possible to use as bleach activators compounds that, under perhydrolysis conditions, yield aliphatic peroxocarboxylic acid having preferably 1 to 10 C atoms, in particular 2 to 4 C atoms, and/or optionally substituted perbenzoic acid. Substances that carry O- and/or N-acyl groups having the aforesaid number of C atoms, and/or optionally substituted benzoyl groups, are suitable. Multiply acylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoyl-succinimide (NOSI), acylated phenolsulfonates, in particular n-nonanoyl- or isononanoyloxybenzensulfonate (n- or iso-NOBS), carboxylic acid anhydrides, in particular phthalic acid anhydride, acylated polyvalent alcohols, in particular triacetin, ethylene glycol diacetate, 2,5-diacetoxy-2,5-dihydrofuran, n -methylmorpholinium-acetonitrile-methyl sulfate (MMA) as well as acetylated sorbitol and mannitol or mixtures thereof (SORMAN), acylated sugar derivatives, in particular pentaacetylglucose (PAG), pentaacetylfructose, tetraacetylxylose, and octaacetyllactose, as well as acetylated, optionally N-alkylated glucamine and gluconolactone, and/or N-acylated lactams, for example N-benzoylcaprolactam, are preferred. Hydrophilically substituted acylacetals and acyllactams are likewise preferred for use. Combinations of conventional bleach activators can also be used.

In addition to or instead of the conventional bleach activators, so-called bleach catalysts can also be used. These substances are bleach-enhancing transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

A further preferred bleach activator usable according to the present invention is a cationic nitrile of formula (I): 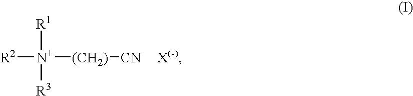
in which R¹ denotes —H, —CH₃, a C₂₋₂₄ alkyl or alkenyl radical, a substituted C₂₋₂₄ alkyl or alkenyl radical having at least one substituent from the group —Cl, —Br, —OH, —NH₂, —CN, an alkyl or alkenylaryl radical having a C₁₋₂₄ alkyl group, or a substituted alkyl or alkenylaryl radical having a C₁₋₂₄ alkyl group and at least one further substituent on the aromatic ring, R² and R³ are selected, independently of one another, from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6, and X is an anion.

The general formula (I) covers a plurality of cationic nitriles that are usable in the context of the present invention. It is particularly advantageous to use cationic nitriles in which R¹ denotes methyl, ethyl, propyl, isopropyl or an n-butyl, n-hexyl, n-octyl, n-decyl, n-dodecyl, n-tetradecyl, n-hexadecyl or n-octadecyl radical. R² and R³ are preferably selected from methyl, ethyl, propyl, isopropyl und hydroxyethyl; one or both radicals can advantageously also be a cyanomethylene radical. The table below characterizes, by way of their R¹, R², and R³ radicals, cationic nitriles of formula (I) that are preferred according to the present invention:

| R¹ | R² | R³ |
|---|---|---|
| —H | —CH₃ | —CH₃ |
| —H | —CH₂—CH₃ | —CH₃ |
| —H | —CH₂—CH₂—CH₃ | —CH₃ |
| —H | —CH(CH₃)—CH₃ | —CH₃ |
| —H | —CH₂—OH | —CH₃ |
| —H | —CH₂—CH₂—OH | —CH₃ |
| —H | —CH(OH)—CH₃ | —CH₃ |
| —H | —CH₂—CH₂—CH₂—OH | —CH₃ |
| —H | —CH₂—CH(OH)—CH₃ | —CH₃ |
| —H | —CH(OH)—CH₂—CH₃ | —CH₃ |
| —H | —(CH₂CH₂—O)₁H | —CH₃ |
| —H | —(CH₂CH₂—O)₂H | —CH₃ |
| —H | —(CH₂CH₂—O)₃H | —CH₃ |
| —H | —(CH₂CH₂—O)₄H | —CH₃ |
| —H | —(CH₂CH₂—O)₅H | —CH₃ |
| —H | —(CH₂CH₂—O)₆H | —CH₃ |
| —CH₃ | —CH₃ | —CH₃ |
| —CH₃ | —CH₂—CH₃ | —CH₃ |
| —CH₃ | —CH₂—CH₂—CH₃ | —CH₃ |
| —CH₃ | —CH(CH₃)—CH₃ | —CH₃ |
| —CH₃ | —CH₂—OH | —CH₃ |
| —CH₃ | —CH₂—CH₂—OH | —CH₃ |
| —CH₃ | —CH(OH)—CH₃ | —CH₃ |
| —CH₃ | —CH₂—CH₂—CH₂—OH | —CH₃ |
| —CH₃ | —CH₂—CH(OH)—CH₃ | —CH₃ |
| —CH₃ | —CH(OH)—CH₂—CH₃ | —CH₃ |
| —CH₃ | —(CH₂CH₂—O)₁H | —CH₃ |
| —CH₃ | —(CH₂CH₂—O)₂H | —CH₃ |
| —CH₃ | —(CH₂CH₂—O)₃H | —CH₃ |
| —CH₃ | —(CH₂CH₂—O)₄H | —CH₃ |
| —CH₃ | —(CH₂CH₂—O)₅H | —CH₃ |
| —CH₃ | —(CH₂CH₂—O)₆H | —CH₃ |
| —CH₂—CH₃ | —CH₂—CH₃ | —CH₃ |
| —CH₂—CH₃ | —CH₂—CH₂—CH₃ | —CH₃ |
| —CH₂—CH₃ | —CH(CH₃)—CH₃ | —CH₃ |
| —CH₂—CH₃ | —CH₂—OH | —CH₃ |
| —CH₂—CH₃ | —CH₂—CH₂—OH | —CH₃ |
| —CH₂—CH₃ | —CH(OH)—CH₃ | —CH₃ |
| —CH₂—CH₃ | —CH₂—CH₂—CH₂—OH | —CH₃ |
| —CH₂—CH₃ | —CH₂—CH(OH)—CH₃ | —CH₃ |
| —CH₂—CH₃ | —CH(OH)—CH₂—CH₃ | —CH₃ |
| —CH₂—CH₃ | —CH₂—CH₃ | —CH₂—CH₃ |
| —CH₂—CH₃ | —CH₂—CH₂—CH₃ | —CH₂—CH₃ |
| —CH₂—CH₃ | —CH(CH₃)—CH₃ | —CH₂—CH₃ |
| —CH₂—CH₃ | —CH₂—OH | —CH₂—CH₃ |
| —CH₂—CH₃ | —CH₂—CH₂—OH | —CH₂—CH₃ |
| —CH₂—CH₃ | —CH(OH)—CH₃ | —CH₂—CH₃ |
| —CH₂—CH₃ | —CH₂—CH₂—CH₂—OH | —CH₂—CH₃ |
| —CH₂—CH₃ | —CH₂—CH(OH)—CH₃ | —CH₂—CH₃ |
| —CH₂—CH₃ | —CH(OH)—CH₂—CH₃ | —CH₂—CH₃ |
| —CH₂—CH₂—CH₃ | —CH₂—CH₂—CH₃ | —CH₃ |
| —CH₂—CH₂—CH₃ | —CH(CH₃)—CH₃ | —CH₃ |
| —CH₂—CH₂—CH₃ | —CH₂—OH | —CH₃ |
| —CH₂—CH₂—CH₃ | —CH₂—CH₂—OH | —CH₃ |
| —CH₂—CH₂—CH₃ | —CH(OH)—CH₃ | —CH₃ |
| —CH₂—CH₂—CH₃ | —CH₂—CH₂—CH₂—OH | —CH₃ |
| —CH₂—CH₂—CH₃ | —CH₂—CH(OH)—CH₃ | —CH₃ |
| —CH₂—CH₂—CH₃ | —CH(OH)—CH₂—CH₃ | —CH₃ |
| —CH₂—CH₂—CH₃ | —CH₂—CH₂—CH₃ | —CH₂—CH₃ |
| —CH₂—CH₂—CH₃ | —CH(CH₃)—CH₃ | —CH₂—CH₃ |
| —CH₂—CH₂—CH₃ | —CH₂—OH | —CH₂—CH₃ |
| —CH₂—CH₂—CH₃ | —CH₂—CH₂—OH | —CH₂—CH₃ |
| —CH₂—CH₂—CH₃ | —CH(OH)—CH₃ | —CH₂—CH₃ |
| —CH₂—CH₂—CH₃ | —CH₂—CH₂—CH₂—OH | —CH₂—CH₃ |
| —CH₂—CH₂—CH₃ | —CH₂—CH(OH)—CH₃ | —CH₂—CH₃ |
| —CH₂—CH₂—CH₃ | —CH(OH)—CH₂—CH₃ | —CH₂—CH₃ |
| —CH(CH₃)—CH₃ | —CH(CH₃)—CH₃ | —CH₃ |
| —CH(CH₃)—CH₃ | —CH₂—OH | —CH₃ |
| —CH(CH₃)—CH₃ | —CH₂—CH₂—OH | —CH₃ |
| —CH(CH₃)—CH₃ | —CH(OH)—CH₃ | —CH₃ |
| —CH(CH₃)—CH₃ | —CH₂—CH₂—CH₂—OH | —CH₃ |
| —CH(CH₃)—CH₃ | —CH₂—CH(OH)—CH₃ | —CH₃ |
| —CH(CH₃)—CH₃ | —CH(OH)—CH₂—CH₃ | —CH₃ |
| —CH(CH₃)—CH₃ | —CH₃ | —CH₂—CH₃ |
| —CH(CH₃)—CH₃ | —CH₂—CH₃ | —CH₂—CH₃ |
| —CH(CH₃)—CH₃ | —CH₂—CH₂—CH₃ | —CH₂—CH₃ |
| —CH(CH₃)—CH₃ | —CH(CH₃)—CH₃ | —CH₂—CH₃ |
| —CH(CH₃)—CH₃ | —CH₂—OH | —CH₂—CH₃ |
| —CH(CH₃)—CH₃ | —CH₂—CH₂—OH | —CH₂—CH₃ |
| —CH(CH₃)—CH₃ | —CH(OH)—CH₃ | —CH₂—CH₃ |
| —CH(CH₃)—CH₃ | —CH₂—CH₂—CH₂—OH | —CH₂—CH₃ |
| —CH(CH₃)—CH₃ | —CH₂—CH(OH)—CH₃ | —CH₂—CH₃ |
| —CH(CH₃)—CH₃ | —CH(OH)—CH₂—CH₃ | —CH₂—CH₃ |

In the interest of easier synthesis, compounds in which radicals R¹ to R³ are identical, for example (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻, are preferred. Cationic nitriles of formula (Ia) 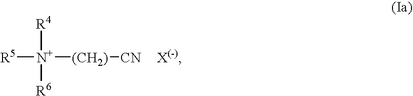
in which R⁴, R⁵, and R⁶ are selected, independently of one another, from —CH₃, —CH₂—CH₃, —CH₂—CH₂—CH₃, —CH(CH₃)—CH₃, such that R⁴ can additionally also be —H and X is an anion, such that preferably R⁵═R⁶═—CH₃ and in particular R⁴═R⁵═R⁶═—CH₃, and compounds of the formulas (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻are particularly preferred.

Particularly preferred are cationic nitriles of formula (I), preferably of formula (Ia), particularly preferably of the formula (CH₃)₃N⁽⁺⁾CH₂—CN X⁻, where X⁻ denotes an anion that is selected from the group chloride, bromide, iodide, hydrogensulfate, methosulfate, laurylsulfate, dodecylbenzenesulfonate, p-toluenesulfonate (tosylate), cumenesulfonate, or xylenesulfonate, or mixtures thereof.

Natural or synthetic polymers, for example, are suitable as binding agents, which either can be mixed in the form of solids with the bleach activators and then granulated with the addition of a granulating liquid, or can be a constituent of the granulating liquid. Preferred thereamong are, for example, polyethylene glycols or polypropylene glycols. Also preferred are nonionogenic polymers such as, for example:
Polyvinylpyrrolidones such as those marketed, for example, under the designation Luviskol® (BASF). Polyvinylpyrrolidones [poly(1-vinyl-2-pyrrolidinones)], abbreviated PVP, are polymers of the general formula (II): 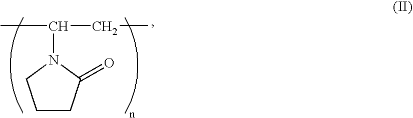
   that are produced by the radical polymerization of 1-vinylpyrrolidone using the method of solution or suspension polymerization with the use of radical formers (peroxides, azo compounds) as initiators. Ionic polymerization of the monomer furnishes only products having low molar weights. Commercially available polyvinylpyrrolidones have molar weights in the range from approx. 2,500 to 750,000 g/mol; they are characterized by indicating the K values and (as a function of K value) possess glass transition temperatures of 130 to 175° C. They are offered as white, hygroscopic powders or as aqueous solutions. Polyvinylpyrrolidones are readily soluble in water and in a plurality of organic solvents (alcohols, ketones, glacial acetic acid, chlorinated hydrocarbons, phenols, and others).
Vinylpyrrolidone/vinyl ester copolymers such as those marketed, for example, under the trademark Luviskol® (BASF). Luviskol® VA 64 and Luviskol® VA 73, each vinylpyrrolidone/vinyl acetate copolymers, are particularly preferred nonionic polymers.

The vinyl ester polymers are polymers accessible from vinyl esters, having the grouping of formula (III) 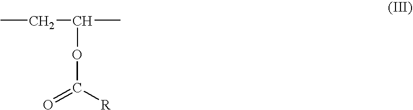
as a characteristic basic module of the macromolecule. Of these, the vinyl acetate polymers (R═CH₃), with polyvinyl acetates have the greatest technical significance as by far the most important representatives.

The vinyl esters are polymerized radically using a variety of methods (solution polymerization, suspension polymerization, emulsion polymerization, substance polymerization). Copolymers of vinyl acetate with vinyl pyrrolidone contain monomer units of formulas (II) and (III).
Cellulose ethers, such as hydroxypropyl cellulose, hydroxyethyl cellulose, and methylhydroxypropyl cellulose, such as those marketed, for example, under the trademarks Culminal® and Benecel® (AQUALON).

Cellulose ethers can be described by the following general formula: 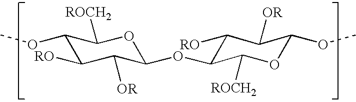
in which R denotes H or an alkyl, alkenyl, alkinyl, aryl, or alkylaryl radical. In preferred products, at least one R in the formula denotes —CH₂CH₂CH₂—OH or —CH₂CH₂—OH. Cellulose ethers are produced industrially by the etherification of alkaline celluloses (e.g. with ethylene oxide). Cellulose ethers are characterized by way of the average degree of substitution DS or the molar degree of substitution MS, which indicate respectively how many hydroxy groups of an anhydroglucose unit of the cellulose have reacted with the etherification reagent, and how many moles of the etherification reagent have attached, on average, to an anhydroglucose unit. Hydroxyethyl celluloses are water-soluble above a DS of approximately 0.6 or an MS of approximately 1. Commercially usual hydroxyethyl and hydroxypropyl celluloses have degrees of substitution in the range of 0.85-1.32 (DS) or 1.5-3 (MS). Hydroxyethyl and -propyl celluloses are marketed as yellowish-white, odorless and tasteless powders, in a wide variety of degrees of polymerization. Hydroxyethyl and -propyl celluloses are soluble in cold and hot water and in some (hydrous) organic solvents, but insoluble in most (anhydrous) organic solvents; their aqueous solutions are relatively insensitive to changes in pH or electrolyte addition.

Polyvinyl alcohols, abbreviated PVALs, are polymers of the general structure
[—CH₂—CH(OH)—]ₙ
which also contain small proportions of structural units of the
[—CH₂—CH(OH)—CH(OH)—CH₂]
type. Because the corresponding monomer (vinyl alcohol) is not stable in its free form, polyvinyl alcohols are produced via polymer-analogous reactions by hydrolysis, but industrially, in particular, by alkaline-catalyzed transesterification of polyvinyl acetates with alcohols (preferably methanol) in solution. These industrial methods also provide access to PVALs that contain a predefinable residual proportion of acetate groups.

Commercially available PVALs (e.g. Mowiole® grades of Clariant) are sold as yellowish-white powders or granulates having degrees of polymerization in the range of approx. 500-2500 (corresponding to molar weights of approx. 20,000-100,000 g/mol), and have different degrees of hydrolysis of 98-99 or 87-89 mol %. They are therefore partially saponified polyvinyl acetates having a residual acetyl-group content of approx. 1-2 or 11-13 mol %.

The water solubility of PVALs can be decreased by subsequent treatment with aldehydes (acetalization), by complexing with Ni or Cu salts, or by treatment with dichromates, boric acid, or borax, and thus adjusted specifically to desired values.

Methods that are particularly preferred according to the present invention are characterized in that natural polymers, preferably cellulose and/or starch, as well as derivatives thereof, in particular carboxymethyl cellulose (CMC) and/or hyd roxypropyl cellulose (HPC) and/or hydroxypropylmethyl cellulose (HPMC), are used as a binding agent.

In steps b) and c) of the method according to the present invention, the granular materials from step a) are coated with a solution or dispersion of at least one complexing agent, and the coated granular materials are dried. Coating can be accomplished simultaneously with drying (for example in a fluidized-bed apparatus in which the granular materials are impinged upon with a solution or dispersion of at least one complexing agent and simultaneously dried), or it is also possible and preferred to perform the drying after the coating, i.e. subsequently in time thereto.

Complexing agents whose solutions or dispersions in a solvent or dispersing agent are used in the method according to the present invention for coating the granular bleach-activator materials are substances that can complex metal ions. Preferred complexing agents are so-called chelate complexing agents, i.e. substances that form cyclic compounds with metal ions, a single ligand occupying more than one coordination site on a central atom, i.e. being at least “double-toothed.” In this case, therefore, normally elongated compounds are closed up into rings by formation of a complex via an ion. The number of bound ligands depends on the coordination number of the central ion.

Common chelate complexing agents that are preferred in the context of the present invention are, for example, polyoxycarboxylic acids, polyamines, ethylenediaminetetraacetic acid (EDTA), and nitrilotriacetic acid (NTA). Also usable according to the present invention are complexing polymers, i.e. polymers that carry, either in the main chain itself or laterally thereto, functional groups that can act as ligands and react with suitable metal atoms, generally forming chelate complexes. The polymer-bound ligands of the resulting metal complexes can derive from only one macromolecule or can belong to different polymer chains. The latter case results in crosslinking of the material, provided the complexing polymers were not already crosslinked via covalent bonds.

Complexing groups (ligands) of usual complexing polymers are iminodiacetic acid, hydroxyquinoline, thiourea, guanidine, dithiocarbamate, hydroxamic acid, amide oxime, aminophosphoric acid, (cyclic) polyamino, mercapto, 1,3-dicarbonyl, and crown ether radicals, having in some cases very specific activities with respect to ions of various metals. Fundamental polymers of many complexing polymers that are also commercially important are polystyrene, polyacrylates, polyacrylonitriles, polyvinyl alcohols, polyvinyl pyridines, and polyethylene imines. Natural polymers such as cellulose, starch, or chitin are also complexing polymers. The latter can additionally be equipped with further ligand functionalities by polymer-analogous conversions.

The use of one or more chelate complexing agents from the groups of the
i) polycarboxylic acids in which the sum of the carboxyl and (if applicable) hydroxyl groups is at least 5;
ii) nitrogen-containing mono- or polycarboxylic acids;
iii) geminal diphosphonic acids;
iv) aminophosphonic acids;
v) phosphonopolycarboxylic acids;
vi) cyclodextrins
   is particularly preferred in the context of the present invention.

All complexing agents of the existing art can be used in the context of the present invention. They can belong to different chemical groups. The following are preferably used, individually or mixed with one another:
a) polycarboxylic acids in which the sum of the carboxyl and (if applicable) hydroxyl groups is at least 5, such as gluconic acid;
b) nitrogen-containing mono- or polycarboxylic acids such as ethylenediaminetetraacetic acid (EDTA), N -hydroxyethylethylenediaminetetraacetic acid, diethylenediaminepentaacetic acid, hydroxyethyliminodiacetic acid, nitridodiacetic acid 3-propionic acid, isoserine diacetic acid, N,N-di-(β-hydroxyethyl)glycine, N-(1,2-dicarboxy-2-hydroxyethyl)g lycine, N-(1,2-dicarboxy-2-hydroxyethyl)aspartic acid, or nitrilotriacetic acid (NTA);
c) geminal diphosphonic acids such as 1-hydroxyethane-1,1-diphosphonic acid (HEDP), its higher homologs having up to 8 carbon atoms, and hydroxy- or amino-group-containing derivatives thereof, and 1-aminoethane-1,1-diphosphonic acid, its higher homologs having up to 8 carbon atoms, and hydroxy- or amino-group-containing derivatives thereof;
d) aminophosphonic acids, such as ethylenediaminetetra(methylphosphonic acid), diethylenetriamine penta(methylenephosphonic acid), or nitrilotri(methylenephosphonic acid);
e) phosphonopolycarboxylic acids such as 2-phosphonobutane-1,2,4-tricarboxylic acid; and
f) cyclodextrins.

In the context of this patent application, polycarboxylic acids a) are understood as carboxylic acids, including monocarboxylic acids, in which the sum of the carboxyl and hydroxyl groups contained in the molecule is at least 5. Complexing agents from the group of the nitrogen-containing polycarboxylic acids, in particular EDTA, are preferred. At the alkaline pH values necessary according to the present invention for the processing solutions, these complexing agents are present at least in part as anions. It is immaterial whether they are introduced in the form of the acids or in the form of salts. If they are used as salts, alkali, ammonium, or alkylammonium salts, in particular sodium salts, are preferred.

Also to be mentioned as further preferred complexing agents are polymeric aminodicarboxylic acids, their salts, or their precursor substances. Particularly preferred are polyaspartic acids and their salts and derivatives, which in addition to co-builder properties also exhibit a bleach-stabilizing effect.

Other suitable complexing agents are polyacetals, which can be obtained by reacting dialdehydes with polyol carboxylic acids that have 5 to 7 C atoms and at least 3 hydroxyl groups. Preferred polyacetals are obtained from dialdehydes such as glyoxal, glutaraldehyde, terephthalaldehyde, and mixtures thereof, and from polyol carboxylic acids such as gluconic acid and/or glucoheptonic acid.

A further substance class having complexing properties is represented by the phosphonates. These are, in particular, hydroxyalkane- and aminoalkanephosphonates. Among the hydroxyalkanephosphonates, 1-hydroxyethane-1,1-diphosphonate (HEDP) is particularly important as a co-builder. It is preferably used as a sodium salt, in which context the disodium salt reacts neutrally and the tetrasodium salt in alkaline fashion (pH 9). Suitable aminoalkanephosphonates are preferably ethylenediaminetetramethylenephosphonate (EDTMP), diethylenetriaminepentamethylenephosphonate (DTPMP), and their higher homologs. They are preferably used in the form of the neutrally reacting sodium salts, e.g. as the hexasodium salt of EDTMP or as the hepta- and octasodium salt of DTPMP. Of the class of the phosphonates, HEDP is preferably used as a complexing agent. The aminoalkanephosphonates furthermore possess a pronounced heavy-metal binding capability. It may accordingly be preferred, especially when the agent also contains bleaches, to use aminoalkanephosphonates, in particular DTPMP, or mixtures of the aforesaid phosphonates. These substances are described below.

Methods preferred according to the present invention are characterized in that phosphonates, preferably hydroxyalkane- or aminoalkanphosphonates, and in particular 1-hydroxyethane-1,1-diphosphonate (HEDP) or its di- or tetrasodium salt, and/or ethylenediaminetetramethylenephosphonate (EDTMP) or its hexasodium salt, and/or diethylenetriaminepentamethylenephosphonate (DTPMP) or its hepta- or octasodium salt, are used.

After drying, the granular material produced according to the present invention contains at least bleach activator, binding agent, and complexing agent as constituents. Methods preferred according to the present invention are characterized in that the dried granular material (including coating) contains, based on its weight, 5 to 80 wt %, preferably 10 to 75 wt %, and in particular 20 to 70 wt % bleach activator(s).

In preferred methods according to the present invention, the concentration of binding agents in the granular materials produced according to the present invention, based on the dried granular material (including coating), is 1 to 50 wt %, preferably 1.5 to 20 wt %, and in particular 2 to 10 wt %.

With respect to the complexing agent, methods according to the present invention are characterized in that the dried granular material (including coating) contains, based on its weight, 0.1 to 50 wt %, preferably 3 to 25 wt %, and in particular 5 to 15 wt % complexing agent.

As already mentioned above, variants of the method according to the present invention in which step a) is performed in a mixer/granulator are preferred, bleach activator(s) and binding agent preferably being provided in solid form and granulated with a granulating liquid. In particularly preferred variants of the method according to the present invention, the granulating liquid is free of surfactant(s) and complexing agent(s).

It was likewise mentioned above that in preferred methods according to the present invention, step b) and optionally step c) are performed in a fluidized-bed apparatus.

Coated bleach activators that can be produced, for example, in accordance with the method according to the present invention are a further subject of the present invention. These are coated bleach activators encompassing a particle core that contains bleach activator(s), and a casing surrounding that core, the casing being made up of complexing agent(s) at a proportion of at least 50 wt %, by preference 70 wt %, more preferably at least 90 wt %, and in particular 100 wt % of its weight.

Coated bleach activators preferred according to the present invention are characterized in that the casing contains as a complexing agent phosphonates, preferably hydroxyalkane- or aminoalkanephosphonates, and in particular 1-hydroxyethane-1,1-diphosphonate (HEDP) or its di- or tetrasodium salt, and/or ethylenediaminetetramethylenephosphonate (EDTMP) or its hexasodium salt, and/or diethylenetriaminepentamethylenephosphonate (DTPMP) or its hepta- or octasodium salt.

It is furthermore preferred that the core of the coated bleach activators according to the present invention not be made up exclusively of bleach activator. A binding agent content in the core of the particle is preferred; in particular, coated bleach activators in which the core contains binding agent in addition to bleach activator(s), natural polymers, preferably cellulose and/or starch as well as their derivatives, in particular carboxymethyl cellulose (CMC) and/or hydroxypropyl cellulose (HPC) and/or hydroxypropylmethyl cellulose (HPMC) being preferred, and preferred quantities of binding agent in the core being 1 to 50 wt %, preferably 5 to 40 wt %, and in particular 10 to 30 wt % binding agent (based in each case on the uncoated core), are preferred embodiments of the present invention.

The coated bleach activators according to the present invention, or produced according to the present invention, are distinguished by good shelf stability and are outstandingly suitable for use in a plurality of agents, in particular washing or cleaning agents. Sensitive substances, for example dyes, in agents having the coated bleach activators according to the present invention, or produced according to the present invention, exhibit much greater stability than in agents having coated bleach activators that are not in accordance with the present invention, or produced according to the present invention.

A further subject of the invention is therefore the use of the coated bleach activators according to the present invention, or produced according to the present invention, in washing or cleaning agents, in particular in washing- or cleaning-agent tablets.

Also a subject of the present invention are washing or cleaning agents containing at least one bleaching agent, at least one dye, and at least one coated bleach activator according to the present invention or produced according to the present invention.

Particularly preferred washing or cleaning agents according to the present invention contain the dye in a homogeneous distribution, i.e. are colored throughout, while individually colored particles (“speckles”) are of subordinate importance in the washing or cleaning agents according to the present invention. In the case of washing or cleaning agents according to the present invention in tablet form, this applies to individual phases (preferably layers) of the tablets; in the case of multi-phase shaped elements, individual phases can also be uncolored or differently colored.

Preferred washing or cleaning agents according to the present invention, in particular automatic dishwashing agents, contain, in addition to the aforementioned constituents (bleaching agent, dye, and coated bleach activators according to the present invention or produced according to the present invention), substances from the groups of the builders and co-builders, surfactants, enzymes, dyes, fragrances, corrosion protection agents, polymers, or of a further usual constituent of washing and cleaning agents. These ingredients are described below.

Builders

According to the present invention, all builders usually used in washing and cleaning agents can be incorporated into the washing and cleaning agents, in particular silicates, carbonates, organic co-builders, and also the phosphates.

Suitable crystalline, layered sodium silicates possess the general formula NaMSiₓO₂ₓ₊₁.y H₂O, where M denotes sodium or hydrogen, x a number from 1.9 to 4, and y is a number from 0 to 20, and preferred values for x are 2, 3, or 4. Preferred crystalline layered silicates of the formula indicated above are those in which M denotes sodium and x assumes the value 2 or 3. Both β- and δ-sodium disilicates Na₂Si₂O₅.y H₂O are particularly preferred.

Also usable are amorphous sodium silicates having a Na₂O:SiO₂ modulus of 1:2 to 1:3.3, preferably 1:2 to 1:2.8, and in particular 1:2 to 1:2.6, which are dissolution-delayed and exhibit secondary washing properties. Dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily be obtained even if the silicate particles yield blurred or even sharp diffraction maxima in electron diffraction experiments. This may be interpreted to mean that the products have microcrystalline regions 10 to several hundred nm in size, values of up to a maximum of 50 nm, and in particular a maximum of 20 nm, being preferred. Densified/compacted amorphous silicates, compounded amorphous silicates, and overdried X-amorphous silicates are particularly preferred.

Both the monoalkali-metal salts and dialkali-metal salts of carbonic acid, and sesquicarbonates, can be contained in the agents as carbonates. Sodium and/or potassium ions represent preferred alkali-metal ions. In an embodiment, it can be preferred to mix in the carbonate and/or bicarbonate, at least in part, separately or subsequently as a further component. Compounds made of, for example, carbonate, silicate, and optionally further adjuvants such as, for example, anionic surfactants or other, in particular organic, builder substances can also be present as separate components in the completed agents.

Use of the commonly known phosphates as builder substances is also possible, of course, provided such use is not to be avoided for environmental reasons. Among the plurality of commercially available phosphates, the alkali-metal phosphates, with particular preference for pentasodium or pentapotassium triphosphate (sodium or potassium polyphosphate) have the greatest significance in the washing and cleaning agent industry.

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in the material being washed, and furthermore contribute to cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders that are very easily soluble in water and that lose their water of crystallization upon heating and transition at 200° C. into the weakly acid diphosphate (disodium hydrogendiphosphate, Na₂H₂P₂O₇), and at higher temperature into sodium trimetaphosphate (Na₃P₃O₉) and Maddrell salt (see below). NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 253° [decomposing to form potassium polyphosphate (KPO₃)ₓ], and is easily soluble in water.

Disodium hydrogenphosphate (secondary sodium phosphate), Na₂HPO₄, is a colorless, very easily water-soluble crystalline salt. It exists anyhdrously and with 2 mol (density 2.066 gcm⁻³, water lost at 95°), 7 mol (density 1.68 gcm⁻³, melting point 48° with loss of 5 H₂O), and 12 mol of water (density 1.52 gcm⁻³, melting point 35° with loss of 5 H₂O); it becomes anhydrous at 100° and when more strongly heated transitions into the diphosphate Na₄P₂O₇. Disodium hydrogenphosphate is produced by the neutralization of phosphoric acid with a soda solution using phenolphthalein as indicator. Dipotassium hydrogenphosphate (secondary or dibasic potassium phosphate), K₂HPO₄, is an amorphous white salt that is easily soluble in water.

Trisodium phosphate (tertiary sodium phosphate), Na₃PO₄, exists as colorless crystals that as the dodecahydrate have a density of 1.62 gcm⁻³ and a melting point of 73-76° C. (decomposition), as the decahydrate (corresponding to 19-20% P₂O₅) a melting point of 100° C., and in anhydrous form (corresponding to 39-40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning agent industry.

Tetrasodium diphosphate (sodium pyrophosphate), Na₄P₂O₇, exists in anhydrous form (density 2.534 gcm⁻³, melting point 988°, also indicated as 880°) and as the decahydrate (density 1.815-1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°.

Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter in particular, a number of designations are in use: fused or thermal phosphates, Graham salt, Kurrol's salt, and Maddrell salt. All the higher sodium and potassium phosphates are together referred to as “condensed” phosphates.

The industrially important pentasodium triphosphate Na₅P₃O₁₀ (sodium tripolyphosphate) is a white, water-soluble, non-hygroscopic salt, crystallizing anhydrously or with 6 H₂O, of the general formula NaO—[P(O)(ONa)—O]ₙ—Na, where n=3. Approximately 17 g of the salt containing no water of crystallization dissolves in 100 g of water at room temperature, approx. 20 g at 60° C., and approx. 32 g at 100°; after the solution is heated to 100° for two hours, approx. 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.). Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing and cleaning agent industry. Sodium potassium tripolyphosphates also exist; these are likewise usable in the context of the present invention. They are produced, for example, when sodium trimetaphosphate is hydrolyzed with KOH:
(NaPO₃)₃+2KOH→Na₃K₂P₃O₁₀+H₂O.

These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

Automatic dishwashing agents that are preferred in the context of the present invention contain no sodium hydroxide and/or potassium hydroxide. The omission of sodium and/or potassium hydroxide as an alkali source has proven to be advantageous in particular when zinc gluconate, zinc formate, and zinc acetate are used as zinc salts.

Co-Builders

Polycarboxylates/polycarboxylic acids, polymeric polycarboxylates, aspartic acid, polyacetals, dextrins, further organic co-builders (see below), and phosphonates can be used in particular as organic co-builders in the washing and cleaning agents in the context of the present invention. The polymers can also be a constituent of the ingredient-containing polymer matrix, but can also be contained, entirely independently thereof, in the agents according to the present invention. The aforesaid substance classes are described below.

Usable organic builder substances are, for example, the polycarboxylic acids that can be used in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, methylglycinediacetic acid, sugar acids, and mixtures thereof.

The acids per se can also be used. The acids typically also possess, in addition to their builder effect, the property of an acidifying component, and thus serve also to establish a lower and milder pH for washing or cleaning agents. To be mentioned in this context are, in particular, citric acid, succinic acid, glutaric acid, adipic acid, gluconic acid, and any mixtures thereof.

Also suitable as builders are polymeric polycarboxylates; these are, for example, the alkali-metal salts of polyacrylic acid or of polymethacrylic acid, for example those having a relative molecular weight from 500 to 70,000 g/mol.

The molar weights indicated for polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural relationship to the polymers being investigated, yields realistic molecular weight values. These indications deviate considerably from the molecular weight indications in which polystyrenesulfonic acids are used as the standard. The molar weights measured against polystyrenesulfonic acids are usually much higher than the molar weights indicated in this document.

Suitable polymers are, in particular, polyacrylates that preferably have a molecular weight from 1000 to 20,000 g/mol. Because of their superior solubility, of this group the short-chain polyacrylates that have molar weights from 1000 to 10,000 g/mI, and particularly preferably from 1200 to 4000 g/mol, may in turn be preferred.

It is particularly preferred to use in the agents according to the present invention both polyacrylates and copolymers of unsaturated carboxylic acids, sulfonic acid group-containing monomers, and optionally further ionic or nonionogenic monomers. The sulfonic acid group-containing copolymers are described in detail below.

In addition, the sulfonic acid group-containing polymers described above can of course also be contained in the agents according to the present invention without necessarily needing to be a constituent of the ingredient-containing polymer matrix.

As already mentioned earlier, both polyacrylates and the above-described copolymers of unsaturated carboxylic acids, sulfonic acid group-containing monomers, and optionally further ionic or nonionogenic monomers are used with particular preference in the agents according to the present invention. The polyacrylates have been described in detail above. Particularly preferred are combinations of the above-described sulfonic acid group-containing copolymers with low-molecular-weight polyacrylates, for example in the range between 1000 and 4000 dalton. Such polyacrylates are obtainable commercially under the trade name Sokalan® PA15 or Sokalan® PA25 (BASF).

Copolymeric polycarboxylates, in particular those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 100,000 g/mol, preferably 20,000 to 90,000 g/mol, and in particular 30,000 to 80,000 g/mol.

The (co)polymeric polycarboxylates can be used either as a powder or as an aqueous solution. The (co)polymeric polycarboxylate content of the agents is preferably 0.5 to 20 wt %, in particular 3 to 10 wt %.

In order to improve water solubility, the polymers can also contain allylsulfonic acids such as, for example, allyloxybenzenesulfonic acid and methallylsulfonic acid, as monomers.

Also particularly preferred are biodegradable polymers made up of more than two different monomer units, for example those that contain salts of acrylic acid and maleic acid, as well as vinyl alcohol or vinyl alcohol derivatives, as monomers, or that contain salts of acrylic acid and 2-alkylallylsulfonic acid, as well as sugar derivatives, as monomers.

Further preferred copolymers preferably comprise, as monomers, acrolein and acrylic acid/acrylic acid salts, or acrolein and vinyl acetate.

Also to be mentioned as further preferred builder substances are polymeric aminodicarboxylic acids, their salts, or their precursor substances. Polyaspartic acids and their salts and derivatives are particularly preferred.

Other suitable builder substances are polyacetals, which can be obtained by reacting dialdehydes with polyol carboxylic acids that have 5 to 7 C atoms and at least 3 hydroxyl groups. Preferred polyacetals are obtained from dialdehydes such as glyoxal, glutaraldehyde, terephthalaldehyde, and mixtures thereof, and from polyol carboxylic acids such as gluconic acid and/or glucoheptonic acid.

Other suitable organic builder substances are dextrins, for example oligomers or polymers of carbohydrates, which can be obtained by partial hydrolysis of starches. The hydrolysis can be performed in accordance with usual, e.g. acid- or enzyme-catalyzed, methods. Preferably these are hydrolysis products having average molar weights in the range from 400 to 500,000 g/mol. A polysaccharide having a dextrose equivalent (DE) in the range from 0.5 to 40, in particular from 2 to 30, is preferred, DE being a common indicator of the reducing effect of a polysaccharide as compared with dextrose, which possesses a DE of 100. Also usable are maltodextrins having a DE between 3 and 20, and dry glucose syrups having a DE between 20 and 37, as well as so-called yellow dextrins and white dextrins having higher molar weights in the range from 2000 to 30,000 g/mol.

The oxidized derivatives of such dextrins are their reaction products with oxidizing agents that are capable of oxidizing at least one alcohol function of the saccharide ring to the carboxylic acid function. A product oxidized at C₆ of the saccharide ring can be particularly advantageous.

Oxydisuccinates and other derivatives of disuccinates, preferably ethylenediaminedisuccinate, are also additional suitable co-builders. Ethylenediamine-N,N′-disuccinate (EDDS) is used here preferably in the form of its sodium or magnesium salts. Also preferred in this context are glycerol disuccinates and glycerol trisuccinates. Suitable utilization quantities in zeolite-containing and/or silicate-containing formulations are 3 to 15 wt %.

Other usable organic co-builders are, for example, acetylated hydroxycarboxylic acids and their salts, which can optionally also be present in lactone form and which contain at least 4 carbon atoms and at least one hydroxy group, as well as a maximum of two acid groups.

A further substance class having co-builder properties is represented by the phosphonates. These are, in particular, hydroxyalkane- and aminoalkanephosphonates. Among the hydroxyalkanephosphonates, 1-hydroxyethane-1,1-diphosphonate (HEDP) is particularly important as a co-builder. It is preferably used as the sodium salt, in which context the disodium salt reacts neutrally and the tetrasodium salt in alkaline fashion (pH 9). Suitable aminoalkanephosphonates are preferably ethylenediaminetetramethylenephosphonate (EDTMP), diethylenetriaminepentamethylenephosphonate (DTPMP), and their higher homologs. They are preferably used in the form of the neutrally reacting sodium salts, e.g. as the hexasodium salt of EDTMP or as the hepta- and octasodium salt of DTPMP. Of the class of the phosphonates, HEDP is preferably used as a builder. The aminoalkanephosphonates furthermore possess a pronounced heavy-metal binding capability. It may accordingly be preferred, especially when the agents also contain bleaches, to use aminoalkanephosphonates, in particular DTPMP, or mixtures of the aforesaid phosphonates.

In addition, all compounds that are capable of forming complexes with alkaline-earth ions can be used as co-builders.

Agents according to the present invention are characterized, in the c ontext of the present application, in that they contain builders, preferably from the group of the silicates, carbonates, organic co-builders, and/or phosphates, in quantities of 0.1 to 99.5 wt %, preferably 1 to 95 wt %, particularly preferably 5 to 90 wt %, and in particular 10 to 80 wt %, in each case based on the agent.

Surfactants

Preferred cleaning agents contain, in the context of the present application, one or more surfactant(s) from the groups of the anionic, nonionic, cationic, and/or amphoteric surfactants.

The anionic surfactants used are, for example, those of the sulfonate and sulfate types. Possibilities as surfactants of the sulfonate type are, preferably, C₉₋₁₃ alkylbenzenesulfonates, olefinsulfonates, i.e. mixtures of alkene- and hydroxyalkanesulfonates, and disulfonates, for example such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm-kernel, or tallow fatty acids, are likewise suitable.

Further suitable anionic surfactants are sulfonated fatty acid glycerol esters. “Fatty acid glycerol esters” are to be understood as the mono-, di- and triesters, and mixtures thereof, that are obtained during production by the esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C₁₂-C ₁₈ fatty alcohols, for example from coconut fatty alcohol, tallow alcohol, lauryl, myristyl, cetyl, or stearyl alcohol, or the C₁₀-C₂₀ oxo alcohols and those semi-esters of secondary alcohols of those chain lengths. Additionally preferred are alk(en)yl sulfates of the aforesaid chain length that contain a synthetic straight-chain alkyl radical produced on a petrochemical basis, that possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-alkyl sulfates that can be obtained, as commercial products of the Shell Oil Company, under the name DAN® are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relative small quantities, for example in quantities of 1 to 5 wt %.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethyoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants (see below for description). Sulfosuccinates whose fatty alcohol radicals derive from ethoxylated fatty alcohols with a restricted homolog distribution are, in turn, particularly preferred. It is likewise also possible to use alk(en)ylsuccinic acid having preferably 8 to 18 carbon atoms in the alk(en)yl chain, or salts thereof.

Further appropriate anionic surfactants are, in particular, soaps. Saturated fatty acid soaps, such as the salts of lauric acid, myristic acid, palmitic acid, stearic acid, hydrogenated erucic acid, and behenic acid, are suitable, as are, in particular, soap mixtures derived from natural fatty acids, e.g. coconut, palm-kernel, or tallow fatty acids.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts, in particular in the form of the sodium salts.

A further group of substances having washing activity is the nonionic surfactants. The nonionic surfactants used are preferably alkoxylated, advantageously ethoxylated, in particular primary alcohols having preferably 8 to 18 carbon atoms and an average of 1 to 12 mol ethylene oxide (EO) per mol of alcohol, in which the alcohol radical can be linear or preferably methyl-branched in the 2- position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethyoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integral or fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

A further class of nonionic surfactants used in preferred fashion, which are used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain, in particular fatty acid methyl esters.

A further class of nonionic surfactants that can advantageously be used is the alkylpolyglycosides (APGs). Usable alkylpolyglycosides conform to the general formula RO(G)_{z}, in which R denotes a linear or branched, in particular methyl-branched in the 2- position, saturated or unsaturated aliphatic radical having 8 to 22, preferably 12 to 18 C atoms, and G is the symbol that denotes a glucose unit having 5 or 6 C atoms, preferably glucose. The glycosidation number z is between 1.0 and 4.0, preferably between 1.0 and 2.0, and in particular between 1.1 and 1.4. Linear alkylpolyglucosides, i.e. alkylpolyglycosides that are made up of a glucose radical and an n-alkyl chain, are preferably used.

Nonionic surfactants of the amine oxide type, for example N-cocalkyl -N,N-dimethylamine oxide and N-tallowalkyl-N,N-dihydroxyethylamine oxide, and the fatty acid alkanolamides, can also be suitable. The quantity of these nonionic surfactants is preferably no more than that of the ethoxylated fatty alcohols, in particular no more than half thereof.

Further suitable surfactants are polyhydroxy fatty acid amides of formula (XVIII): 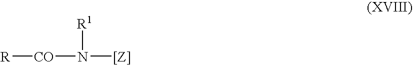
in which RCO denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of formula (XIX): 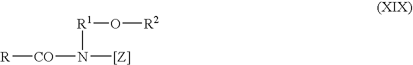
in which R denotes a linear or branched alkyl or alkenyl radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a sugar, for example glucose, fructose, maltose, lactose, galactose, mannose, or xylose. The N -alkoxy- or N-aryloxy-substituted compounds can then be converted into the desired polyhydroxy fatty acid amides by reaction with fatty acid methyl esters in the presence of an alkoxide as catalyst.

In washing and cleaning agents for automatic dishwashing, all surfactants are in general suitable as surfactants. The nonionic surfactants described above, however, and in this case especially the low-foaming nonionic surfactants, are preferred for this application. The alkoxylated alcohols, in particular the ethoxylated and/or propoxylated alcohols, are particularly preferred. One skilled in the art generally understands “alkoxylated alcohols” to be the reaction products of an alkylene oxide, preferably ethylene oxide, with alcohols, preferably (for purposes of the present invention) the longer-chain alcohols (C₁₀ to C₁₈, preferably between C₁₂ and C₁₆, such as, for example, C₁₁, C₁₂, C₁₃, C₁₄, C₁₅, C₁₆ ,C₁₇, and C₁₈ alcohols). As a rule, n mol ethylene oxide and one mol alcohol yield, depending on the reaction conditions, a complex mixture of addition products having different degrees of ethoxylation. A further embodiment consists in the use of mixtures of the alkylene oxides, preferably the mixture of ethylene oxide and propylene oxide. It is also possible, if desired, by way of a concluding etherification with short-chain alkyl groups such as, preferably, the butyl group, to arrive at the substance class of the “capped” alcohol ethoxylates, which can likewise be used for purposes of the present invention. Highly ethoxylated fatty alcohols, or mixtures thereof with end-capped fatty alcohol ethoxylates, are very particularly preferred for purposes of the present invention.

Low-foaming nonionic surfactants that have alternating ethylene oxide and alkylene oxide units have proven to be particularly preferred nonionic surfactants in the context of the present invention. Preferred among these, in turn, are surfactants having EO-AO-EO-AO blocks, one to ten EO and AO groups being bound to one another in each case before a block of the respectively other group follows. Preferred here are automatic dishwashing agents according to the present invention that contain, as nonionic surfactant(s), surfactants of the general formula (XX): 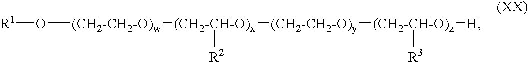
in which R¹ denotes a straight-chain or branched, saturated or mono- or polyunsaturated C₆₋₂₄ alkyl or alkenyl radical; each R² and R³ group, independently of one another, is selected from —CH₃, —CH₂CH₃, —CH₂CH₂—CH₃, CH(CH₃)₂; and the indices w, x, y, z denote, independently of one another, whole numbers from 1 to 6.

The preferred nonionic surfactants of formula XX can be produced, using known methods, from the corresponding alcohols R¹—OH and ethylene oxide or alkylene oxide. The R¹ radical in formula XX above can vary depending on the provenience of the alcohol. If natural sources are used, the R¹ radical has an even number of carbon atoms and is generally unbranched, the linear radicals from natural-origin alcohols having 12 to 18 carbon atoms, e.g. from coconut, palm, tallow, or oleyl alcohol, being preferred. Alcohols accessible from synthetic sources are, for example, the Guerbet alcohols or radicals methyl-branched in the 2-position, or mixed linear and methyl-branched radicals, such as those usually present in oxo alcohol radicals. Regardless of the type of alcohol used to produce the nonionic surfactants contained according to the present invention in the agents, automatic dishwashing agents according to the present invention in which R¹ in formula I denotes an alkyl radical having 6 to 24, preferably 8 to 20, particularly preferably 9 to 15, and in particular 9 to 11 carbon atoms, are preferred.

In addition to propylene oxide, butylene oxide in particular is possible as the alkylene oxide unit that is contained in the preferred nonionic surfactants alternatingly with the ethylene oxide unit. Also suitable, however, are further alkylene oxides in which R² and R³ are selected, independently of one another, from —CH₂CH₂—CH₃ and CH(CH₃)₂. Preferred automatic dishwashing agents are characterized in that R² and R³ denote a —CH₃ radical; w and x, independently of one another, denote values of 3 or 4; and z, independently of one another, denote values of 1 or 2.

In summary, nonionic surfactants that comprise a C₉₋₁₅ alkyl radical having 1 to 4 ethylene oxide units, followed by 1 to 4 propylene oxide units, followed by 1 to 4 ethylene oxide units, followed by 1 to 4 propylene oxide units, are particularly preferred for use in the agents according to the present invention.

Low-foaming nonionic surfactants are used as preferred additional surfactants. With particular preference, the automatic dishwashing agents according to the present invention contain a nonionic surfactant that has a melting point above room temperature. Preferred agents are consequently characterized in that they contain nonionic surfactant(s) having a melting point above 20° C., preferably above 25° C., particularly preferably between 25 and 60° C., and in particular between 26.6 und 43.3° C.

Suitable nonionic surfactants, in addition to the nonionic surfactants contained according to the present invention in the agents, that exhibit melting or softening points in the aforesaid temperature range are, for example, low-foaming nonionic surfactants that can be solid or highly viscous at room temperature. If nonionic surfactants that are highly viscous at room temperature are used, it is preferred that they exhibit a viscosity greater than 20 Pas, preferably greater than 35 Pas, and in particular greater than 40 Pas. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with structurally more complex surfactants such as polyoxypropylene /polyoxyethylene/polyoxypropylene (PO/EO/PO) surfactants. Such PO/EO/PO nonionic surfactants are moreover characterized by good foam control.

In a preferred embodiment of the present invention, the nonionic surfactant having a melting point above room temperature is an ethoxylated nonionic surfactant that has resulted from the reaction of a monohydroxyalkanol or alkyl phenol having 6 to 20 carbon atoms with preferably at least 12 mol, particularly preferably at least 15 mol, in particular at least 20 mol, of ethylene oxide per mol of alcohol or alkyl phenol.

A nonionic surfactant that is solid at room temperature and is particularly preferred for use is obtained from a straight-chain fatty alcohol having 16 to 20 carbon atoms (C₁₆₋₂₀ alcohol), preferably a C₁₈ alcohol, and at least 12 mol, preferably at least 15 mol, and in particular at least 20 mol of ethylene oxide. Of these, the so-called “narrow range ethoxylates” (see above) are particularly preferred.

Accordingly, particularly preferred agents according to the present invention contain ethoxylated nonionic surfactant(s) that was/were obtained from C₆₋₂₀ monohydroxyalkanols or C₆₋₂₀ alkyl phenols or C₁₆₋₂₀ fatty alcohols and more than 12 mol, preferably more than 15 mol, and in particular more than 20 mol ethylene oxide per mol of alcohol.

The nonionic surfactant preferably additionally possesses propylene oxide units in the molecule. Such PO units preferably constitute up to 25 wt %, particularly preferably up to 20 wt %, and in particular up to 15 wt % of the entire molar weight of the nonionic surfactant. Particularly preferred nonionic surfactants are ethoxylated monohydroxyalkanols or alkyl phenols that additionally comprise polyoxyethylene-polyoxypropylene block copolymer units. The alcohol or alkyl phenol portion of such nonionic surfactant molecules preferably makes up more than 30 wt %, particularly preferably more than 50 wt %, and in particular more than 70 wt % of the total molar weight of such nonionic surfactants. Preferred automatic dishwashing agents are characterized in that they contain ethoxylated and propoxylated nonionic surfactants in which the propylene oxide units in the molecule constitute up to 25 wt %, preferably up to 20 wt %, and in particular up to 15 wt % of the total molar weight of the nonionic surfactant.

Additional nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene with 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

A further preferred automatic dishwashing agent according to the present invention contains nonionic surfactants of the formula
R¹O[CH₂CH(CH₃)O]ₓ[CH₂CH₂O]_{y}[CH₂CH(OH)R²],
in which R¹ denotes a linear or branched aliphatic hydrocarbon radical having 4 to 18 carbon atoms, or mixtures thereof; R² a linear or branched hydrocarbon radical having 2 to 26 carbon atoms, or mixtures thereof: and x denotes values between 0.5 and 1.5 and y denotes a value of at least 15.

Additional nonionic surfactants that are usable in preferred fashion are the end-capped poly(oxyalkylated) nonionic surfactants of the formula
R¹O[CH₂CH(R³)O]ₓ[CH₂]ₖCH(OH)[CH₂]ⱼOR²,
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5. If the value of x≧2, each R³ in the formula above can be different. R¹ and R² are preferably linear or branched, saturated or unsaturated, aliphatic or aromatic hydrocarbon radicals having 6 to 22 carbon atoms, radicals having 8 to 18 C atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³═H) or propylene oxide (R³═CH₃) units that can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred end-capped poly(oxyalkylated) alcohols of the above formula have values of k=1 and j=1, so that the formula above is simplified to
R¹O[CH₂CH(R³)O]ₓCH₂CH(OH)CH₂OR².

In the latter formula, R¹, R², and R³ are as defined above, and x denotes numbers from 1 to 30, preferably from 1 to 20, and in particular from 6 to 18. Surfactants in which the R¹ and R² radicals have 9 to 14 C atoms, R³ denotes H, and x assumes values from 6 to 15, are particularly preferred.

Summarizing what has just been stated, preferred dishwashing agents according to the present invention are those containing end-capped poly(oxyalkylated) nonionic surfactants of the formula
R¹O[CH₂CH(R³)O]ₓ[CH₂]ₖCH(OH)[CH₂]ⱼOR²,

in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and k and j denote values between 1 and 12, preferably between 1 and 5, surfactants of the
R¹O[CH₂CH(R³)O]ₓCH₂CH(OH)CH₂OR²
type, in which x denotes numbers from 1 to 30, preferably from 1 to 20, and in particular from 6 to 18, being particularly preferred.

In combination with the aforesaid surfactants, anionic, cationic, and/or amphoteric surfactants can also be used, these being of only subordinate importance in automatic dishwashing agents because of their foaming behavior, and being used for the most part only in quantities of less than 10 wt %, usually in fact less than 5 wt %, for example from 0.01 to 2.5 wt %, in each case based on the agent. The agents according to the present invention can therefore also contain anionic, cationic, and/or amphoteric surfactants as surfactant components.

In the context of the present invention, it is preferred that the automatic dishwashing agents contain surfactant(s), preferably nonionic surfactant(s), in quantities of 0.5 to 10 wt %, preferably 0.75 to 7.5 wt %, and in particular 1.0 to 5 wt %, based in each case on the entire agent.

Bleaching Agents

Bleaching agents are important constituents of washing and cleaning agents, and a washing and cleaning agent can contain, in the context of the present invention, one or more substances from the stated group. Of the compounds serving as bleaching agents that yield H₂O₂ in water, sodium percarbonate has particular importance. Additional usable bleaching agents are, for example, sodium perborate tetrahydrate and sodium perborate monohydrate, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid.

“Sodium percarbonate” is a designation, used in nonspecific fashion, for sodium percarbonate peroxohydrates that strictly speaking are not “percarbonates” (i.e. salts of percarbonic acid) but rather hydrogen peroxide adducts to sodium carbonate. The commercial product has an average composition of 2 Na₂CO₃.3H₂O₂, and is therefore not a peroxycarbonate. Sodium percarbonate forms a white, water-soluble powder of density 2.14 gcm⁻³ that readily decomposes into sodium carbonate and oxygen having a bleaching and oxidizing action.

Sodium percarbonate peroxohydrate was first obtained in 1899 by precipitation with ethanol from a solution of sodium carbonate in hydrogen peroxide, but was erroneously considered a peroxycarbonate. Not until 1909 was the compound recognized to be a hydrogen peroxide addition compound, but the traditional designation “sodium percarbonate” has become established in practical use.

Sodium percarbonate is produced predominantly by precipitation from an aqueous solution (so-called “wet method”). In this, aqueous solutions of sodium carbonate and hydrogen peroxide are combined, and the sodium percarbonate is precipitated using salting-out agents (predominantly sodium chloride), crystallization adjuvants (e.g. polyphosphates, polyacrylates), and stabilizers (e.g. Mg²⁺ ions). The precipitated salt, which still contains 5 to 12 wt % mother liquor, is then centrifuged off and dried in fluidized-bed driers at 90° C. The bulk weight of the final product can fluctuate between 800 and 1200 g/l depending on the production process. As a rule, the percarbonate is stabilized with an additional coating. Coating methods and substances that are used for coating are extensively described in the patent literature. In principle, all commercially usual percarbonate grades can be used according to the present invention, such as those offered, for example, by the Solvay Interox, Degussa, Kemira, or Akzo companies.

Cleaning agents for automatic dishwashing can also contain bleaching agents from the group of the organic bleaching agents. Typical organic bleaching agents that can be used as ingredients in the context of the present invention are the diacyl peroxides, for example dibenzyol peroxide. Further typical organic bleaching agents are the peroxy acids; the alkylperoxy acids and arylperoxy acids are mentioned in particular as examples. Preferred representatives are (a) peroxybenzoic acid and its ring-substituted derivatives, such as alkylperoxybenzoic acids, but also peroxy-α-naphthoic acid and magnesium monoperphthalate; (b) the aliphatic or substituted aliphatic peroxy acids, such as peroxylauric acid, peroxystearic acid, ε-phthalimidoperoxyhexanoic acid (PAP), o-carboxybenzamidoperoxyhexanoic acid, N-nonenylamidoperoxyadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminoperhexanoic acid).

Substances that release chlorine or bromine can also be used according to the present invention as bleaching agents for automatic dishwashing. Appropriate among the materials releasing chlorine or bromine are, for example, heterocyclic N-bromamide and N-chloramides, for example trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Advantageous agents in the context of the present invention contain one or more bleaching agents, preferably from the group of the oxygen or halogen bleaching agents, in particular the chlorine bleaching agents, with particular preference for sodium percarbonate and/or sodium perborate monohydrate, in quantities of 0.5 to 40 wt %, preferably 1 to 30 wt %, particularly preferably 2.5 to 25 wt %, and in particular 5 to 20 wt %, based in each case on the entire agent.

Enzymes

Suitable enzymes are, in particular, those of the hydrolase classes, such as the proteases, esterases, lipases and lipolytically active enzymes, amylases, cellulases and other glycosyl hydrolases, and mixtures of the aforesaid enzymes. All these hydrolases contribute, during washing, to the removal of stains such as protein-, grease-, or starch-containing stains, and graying. Cellulases and other glycosyl hydrolases can moreover contribute to color retention and to enhanced textile softness by removing pilling and microfibrils. Oxidoreductases can also be used for bleaching and to inhibit color transfer. Enzymatic ingredients obtained from bacterial strains or fungi, such as Bacillus subtilis, Bacillus licheniformis, Streptomyceus griseus, Coprinus cinereus, and Humicola insolens, and from their variants modified by genetic engineering, are particularly suitable. Proteases of the subtilisin type, and in particular proteases obtained from Bacillus lentus, are preferably used. Enzyme mixtures, for example of protease and amylase or protease and lipase or lipolytically active enzymes, or protease, amylase, and lipase or lipolytically active enzymes, or protease, lipase or lipolytically active enzymes, and cellulase, but in particular protease- and/or lipase-containing mixtures or mixtures with lipolytically active enzymes, are of particular interest in this context. Examples of such lipolytically active enzymes are the known cutinases.

Peroxidases or oxidases have also proven suitable in certain cases. The suitable amylases include, in particular, α-amylases, isoamylases, pullulanases, and pectinases. Cellobiohydrolases, endoglucanases, and β-glucosidases, which are also called cellobiases, and mixtures thereof, are preferably used as cellulases. Because different types of cellulase have different CMCase and avicelase activities, the desired activities can be set by means of controlled mixtures of the cellulases.

The enzymes can be adsorbed onto carrier substances or embedded in encasing substances in order to protect them from premature decomposition. Preferred agents according to the present invention contain enzymes, preferably in the form of liquid and/or solid enzyme preparations, in quantities of 0.1 to 10 wt %, preferably 0.5 to 8 wt %, and in particular 1 to 5 wt %, based in each case on the entire agent.

Dyes

In order to improve the aesthetic impression of the washing and cleaning agents, they can be colored with suitable dyes. Dyes preferred in the context of the present invention, the selection of which will present absolutely no difficulty to one skilled in the art, possess excellent shelf stability and insensitivity to the other ingredients of the agents and to light, and no pronounced substantivity with respect to textile fibers, in order not to color them.

Preferred for use in the washing and cleaning agents according to the present invention are all coloring agents that can be oxidatively destroyed in the cleaning process, as well as mixtures thereof with suitable blue dyes, so-called blue toners. It has proven to be advantageous to use coloring agents that are soluble in water or at room temperature in liquid organic substances. Anionic coloring agents, e.g. anionic nitroso dyes, are suitable, for example. One possible coloring agent is, for example, naphthol green (Color Index (CI) Part 1: Acid Green 1; Part 2: 10020), which is available as a commercial product, for example, as Basacid® Green 970 of BASF, Ludwigshafen, as well as mixtures thereof with suitable blue dyes. Pigmosol® Blue 6900 (CI 74160), Pigmosol® Green 8730 (CI 74260), Basonyl® Red 545 FL (CI 45170), Sandolan® Rhodamine EB400 (CI 45100), Basacid® Yellow 094 (CI 47005), Sicovit® Patent Blue 85 E 131 (CI 42051), Acid Blue 183 (CAS 12217-22-0, CI Acid Blue 183), Pigment Blue 15 (CI 74160), Supranol® Blue GLW (CAS 12219-32-8, CI Acid Blue 221)), Nylosan® Yellow N-7GL SGR (CAS 61814-57-1, CI Acid Yellow 218) and/or Sandolan® Blue (CI Acid Blue 182, CAS 12219-26-0) are used as further coloring agents.

Particularly preferred in the context of the present invention are the dyes recited below. The first name indicates the designation of the dye; the second designation is the generic name in the Color Index (C.I. generic name); the five-digit number is the number of the relevant dye in the Color Index (C.I. No.); and a three- or four-digit number followed by a dash, a two-digit number, a further dash, and a single-digit number, indicates the Chemical Abstracts number (CAS No.):
Sicovit Amaranth 85 E 123; Acid Red 27; 16185; 915-67-3
Iragon Bright Pink liquid; Acid Red 52+
Acid Blue 80; 45100 61585; 352042-1; 4474-24-2
Vitasyn Ponceau 4RC 82
Basovit Red 400 E; Acid Red 18; 16255; 2611-82-7
Duasyn Red R-F3B liquid; Reactive Red 180; 181055;
Dragocolor Rhodamine EB4; Acid Red 52; 45100; 3520-42-1
Sandolan Rhodamine EB 400;
Telon Red M-GWN; Acid Red 276;
D&C Red No. 33 K 7057; Acid Red 33; 17200; 3567-66-6
Lilas solide W5001; Xanthenic dye (Acid Violet 9); 45190; 6252-76-2
Liquitint Red ST; (Disperse Red 156); (11235);
Sicovit Tartrazine 85 E 102
E 102 Giallo Tartrazina HC
Food Yellow 4,
Acid Yellow 23; 19140; 1934-21-0
Sicovit Quinoline Yellow 70 E 104; Acid Yellow 3; (Food Yellow 13 ); 47005; 8004-92-0; 95139-83-2
Basacid Yellow 094; Acid Yellow 3; 47005; 8004-92-0
Sudan Yellow 172 liquid; Solvent Yellow 174;
Macrolex Yellow G; Disperse Yellow 54
Solvent Yellow 114; 47020;
Iragon Bright Yellow liquid; Acid Yellow 17; 18965; 6359-984
Sanolin Yellow BG; Direct Yellow 28; 19555;
Cosmenyl Yellow 10 G; Pigment Yellow 3; 11710;
FAT Yellow 3 G ; Solvent Yellow 16; 12700; 4314-14-1
Liquitint Yellow LP; (Disperse Yellow 31); (48000);
E110 Sunset Yellow; Food Yellow 3; 15985; 2783-94-0
Liquitint Yellow BL; (Acid Orange 52); (13025);
Color Guide 40; ; ;
Basacid Green 970; Acid Green 1; 10020; 19381-50-1
Verde Basacid T 461 Liquid; Acid Yellow 9+
Acid Blue 9; 19140+; 42090; 1934-21-0
Disperse Green 87-3007; Pigment Green 7; 74260;
Pyranine 120%; Solvent Green 7; 59040;
Macrolex Green 5 B; Solvent Green 3; 61565;
Hostafine Green GN; Pigment Green 7; 74260; 1328-53-6
Liquitint Teal; ; (42165);
PV Fast green GNX; Pigment Green 7; 74260; 1328-53-6
Color Guide 40; ; ;
Basacid Azul V20; Acid Blue 3; 42051; 353649-0
Basacid Blue 762 liquid; Direct Blue 199; 74190; 12222-04-7
Disperse Blue 69-0007 paste; Pigment Blue 15:1; 74160; 147-14-8
Iragon Blue ABL 9; Acid Blue 9; 42090; 2650-18-2
Iragon brilliant blue liquid; Acid Blue 80+
Acid red 52; 61585; 45100; 4474-24-2; 352042-1 Iragon Blue ABL 182 liquid; Acid Blue 182; not ex.; 12219-26-0 72152-54-6
Sanolin Blue EHRL p—; Acid Blue 182; not ex.; 72152-54-6
Cosmenyl Blue A2R; Pigment Blue 15:1; 74160; 147-14-8
Hostafine-Blue B2G liquid; Pigment Blue 15:3; 74160; 147-14-8
Sandoplast Blue 2B p; Solvent Blue 104; 61568; 116-75-6
Supranol Blue GLW; Acid Blue 221; not ex.; 12219-32-8
Sicovit Patent Blue 85 E 131; E 131 Patent Blue 85%; Acid Blue 3,
Food Blue 5, 42051; 353649-0
Liquitint Blue MC; (Acid Blue 9); (42090);
Basacid Blue 756 liquid ; Acid Blue 9; 42090; 384445-9
Basacid Yellow 093 liquid; Acid Yellow 3; 47005;
Telon Blue RR;
Sanolin Rhodamine E-B 400; Acid Red 52; 45100; 352042-1
Pigmosol Green 8730; Pigment Green 7; 74260; 1328-53-6
Sicovit Green Z 6120 ; Acid Blue 3+Tartrazine; 42051+19140; 1934-21-0+353649-0

In selecting the coloring agent, care must be taken that the coloring agents do not exhibit too great an affinity for textile surfaces, and here in particular with respect to synthetic fibers. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, e.g. the aforementioned Basacid® Green or (likewise aforesaid) Sandolan® Blue, coloring-agent concentrations in the range of a few 10⁻² to 10⁻³ wt % are typically selected. In the case of the pigment dyes, on the other hand, which are particularly preferred because of their brilliance but are less readily water-soluble, e.g. the aforesaid Pigmosol® dyes, the appropriate concentration of the coloring agent in the washing or cleaning agent is typically a few 10⁻³ to 10⁻⁴ wt %.

Fragrances

Fragrances are added to the agents in the context of the present invention in order to improve the aesthetic impression of the products and to make available to the user, in addition to the performance of the product, a product that is visually and sensorially “typical and unmistakable.”

Individual aroma compounds, e.g. the synthetic products of the ester, ether, aldehyde, ketone, alcohol, and hydrocarbon types, can be used in the context of the present invention as perfume oils or fragrances. Aroma compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes, for example, the linear alkanals having 8-18 C atoms, citral, citronellal, citronellyloxyacetaldehyde, cyclamenaldehyde, hydroxycitronellal, lilial and bourgeonal; the ketones, for example, the ionones, α-isomethylionone und methylcedryl ketone; the alcohols, anethol, citronellol, eugenol, geraniol, linalool, phenylethyl alcohol and terpineol; the hydrocarbons include principally the terpenes such as limonene and pinene.

Preferably, however, mixtures of different aromas that together produce an appealing fragrance note are used. Such perfume oils can also contain natural aroma mixtures, such as those accessible from plant sources, for example pine, citrus, jasmine, patchouli, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

Corrosion Protection Agents

Cleaning agents for automatic dishwashing can contain corrosion inhibitors to protect the machine or the items being washed; silver protection agents, in particular, are especially important in the field of automatic dishwashing. Known substances of the existing art are usable. In general, silver protection agents can be selected principally from the group of the triazoles, benzotriazoles, bisbenzotriazoles, aminotriazoles, alkylaminotriazoles, and the transition-metal salts or complexes. It is particularly preferred to use benzotriazole and/or alkylaminotriazole. Cleaner formulations moreover often comprise agents containing active chlorine, which agents can greatly decrease the corrosion of silver surfaces. In chlorine-free cleaners, oxygen- and nitrogen-containing organic redox-active compounds are used in particular, such as di- and trivalent phenols, e.g. hydroquinone, catechol, hydroxyhydroquinone, gallic acid, phloroglucine, pyrogallol, and derivatives of these classes of compounds. Salt-like and complex-like inorganic compounds, for example salts of the metals Mn, Ti, Zr, Hf, V, Co, and Ce, are also often used. Preferred in this context are the transition-metal salts that are selected from the group of the manganese and/or cobalt salts and/or complexes, in particularly preferred fashion the cobalt(ammine) complexes, cobalt(acetate) complexes, cobalt(carbonyl) complexes, the chlorides of cobalt or manganese, and manganese sulfate, as well as the manganese complexes
[Me-TACN)Mn^{IV}(m-0)₃Mn^{IV}(Me-TACN)]²⁺(PF₆⁻)₂,
[Me-MeTACN)Mn^{IV}(m-0)₃Mn^{IV}(Me-MeTACN)]²⁺(PF₆⁻)₂,
[Me-TACN)Mn^{III}(m-0)(m-OAc)₂Mn^{III}(Me-TACN)]²⁺(PF₆⁻)₂, and
[Me-MeTACN)Mn^{III}(m-0)(m-OAc)₂Mn^{III}(Me-MeTACN)]²⁺(PF₆⁻)₂, in which Me-TACN denotes 1,4,7-trimethyl-1,4,7-triazacyclononane and Me-MeTACN denotes 1,2,4,7-tetramethyl-1,4,7-triazacyclononane. Zinc compounds can also be used to prevent corrosion of the items being washed.

Preferred in the context of the present invention are automatic dishwashing agents that additionally contain at least one silver protection agent selected from the group of the triazoles, benzotriazoles, bisbenzotriazoles, aminotriazoles, alkylaminotriazoles, preferably benzotriazole and/or alkylaminotriazole, in quantities of 0.001 to 1 wt %, preferably 0.01 to 0.5 wt %, and in particular 0.05 to 0.25 wt %, based in each case on the entire agent.

1-13. (canceled)

14. A method comprising:
(a) granulating at least one bleach activator with at least one binding agent to form a granular material;
(b) coating the granular material with a solution or dispersion comprising at least one complexing agent to form a coated granular material; and
(c) drying the coated granular material.

15. The method according to claim 14, wherein the at least one binding agent comprises a natural polymer.

16. The method according to claim 14, wherein the at least one binding agent comprises a natural polymer selected from the group consisting of celluloses and starches.

17. The method according to claim 14, wherein the at least one complexing agent comprises a phosphonate.

18. The method according to claim 14, wherein the at least one complexing agent comprises a phosphonate selected from the group consisting of hydroxyalkane phosphonates and aminoalkane phosphonates.

19. The method according to claim 14, wherein the at least one complexing agent comprises a phosphonate selected from the group consisting of 1-hydroxyethane-1,1-diphosphonate and salts thereof, ethylenediaminetetramethylenephosphonate and salts thereof, and diethylenetriaminepentamethylenephosphonate and salts thereof.

20. The method according to claim 14, wherein the coated granular material after drying comprises the at least one bleach activator in an amount of 5 to 80% by weight based on the weight of the dried coated granular material.

21. The method according to claim 14, wherein the coated granular material after drying comprises the at least one binding agent in an amount of 1 to 50% by weight based on the weight of the dried coated granular material.

22. The method according to claim 14, wherein the coated granular material after drying comprises the at least one complexing agent in an amount of 0.1 to 50% by weight based on the weight of the dried coated granular material.

23. The method according to claim 14, wherein the granulating is carried out in a mixer/granulator.

24. The method according to claim 14, wherein the at least one binding agent is provided in solid form.

25. The method according to claim 14, wherein granulating is carried out with a granulating liquid.

26. The method according to claim 25, wherein the granulating liquid is free of surfactants and complexing agents.

27. The method according to claim 14, wherein coating is carried out in a fluidized-bed apparatus.

28. The method according to claim 14, wherein coating and drying is carried out in a fluidized-bed apparatus.

29. A method comprising:
(a) granulating at least one bleach activator with at least one binding agent to form a granular material, wherein the at least one binding agent comprises a natural polymer;
(b) coating the granular material with a solution or dispersion comprising at least one complexing agent to form a coated granular material, wherein the at least one complexing agent comprises a phosphonate; and
(c) drying the coated granular material; wherein the coated granular material after drying comprises the at least one bleach activator in an amount of 5 to 80% by weight, the at least one binding agent in an amount of 1 to 50% by weight, and the at least one complexing agent in an amount of 0.1 to 50% by weight based on the weight of the dried coated granular material.

30. A coated bleach activator comprising: (i) a core having a core surface, wherein the core comprises at least one bleach activator; and (ii) a casing on the core surface wherein the casing comprises at least one complexing agent present in an amount of at least 50% by weight based on the weight of the casing.

31. The coated bleach activator according to claim 30, wherein the core further comprises at least one binding agent.

32. The coated bleach activator according to claim 31, wherein the at least one binding agent comprises a natural polymer.

33. The coated bleach activator according to claim 31, wherein the at least one binding agent comprises a natural polymer selected from the group consisting of celluloses and starches.

34. The coated bleach activator according to claim 30, wherein the at least one complexing agent comprises a phosphonate.

35. The coated bleach activator according to claim 30, wherein the at least one complexing agent comprises a phosphonate selected from the group consisting of hydroxyalkane phosphonates and aminoalkane phosphonates.

36. The coated bleach activator according to claim 30, wherein the at least one complexing agent comprises a phosphonate selected from the group consisting of 1-hydroxyethane-1,1-diphosphonate and salts thereof, ethylenediaminetetramethylenephosphonate and salts thereof, and diethylenetriaminepentamethylenephosphonate and salts thereof.

37. A washing or cleaning agent comprising at least one bleaching agent, at least one dye and at least one coated bleach activator according to claim 30.
